(19) United States
(12) Patent Application Publication
(10) Pub. No.: US 2009/0024552 A1
(43) Pub. Date: Jan. 22, 2009

(54) UNIFIED DEVELOPMENT GUIDELINES

(75) Inventor: Udo Klein, Maximiliansau (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/780,782

(22) Filed: Jul. 20, 2007

(51) Int. Cl. G06N 5/02

(52) U.S. Cl. 706/47

(57) ABSTRACT

This disclosure relates to creating, facilitating, or otherwise managing unified development guidelines. Software for managing development guidelines can comprise computer readable instructions operable when executed to, in response to a trigger, identify a first guideline rule and a second guideline rule based, at least in part, on the trigger, where the guideline rules are at least partially stored in a central rules repository for a development group and each rule is associated with a validity period. This software then generates a development guideline using the identified first guideline rule and the second guideline rule.

### TECHNICAL FIELD

This disclosure relates to computer systems and methods and, more particularly, to methods, systems, and software for creating, facilitating, or otherwise managing unified development guidelines and rules thereof.

### BACKGROUND

Enterprise software systems are generally large and complex. For example, a business application may be used to track information that relates to a business by obtaining and integrating finance, sales, and materials data. Such systems can require many different components, distributed across different hardware platforms, and possibly in several different geographical locations. In order to design, configure, update or implement the enterprise software system, one is required to understand details of the system at varying levels, depending on his role in using, designing, managing, coding, or implementing the system. For example, a systems administrator may need a high-level technical understanding of how various software modules are installed on physical hardware, such as a server device or a network, and how those software modules interact with other software modules in the system. A person responsible for configuring the software may need a high-level functional understanding of the operations that each functional component provides. An application designer may need a low-level technical understanding of the various software interfaces that portions of the application require or implement. And an application developer may need a detailed understanding of the interfaces and functionality he is implementing in relation to the remainder of the system. Specialized programming languages have been developed for writing software, such as business applications. One example of such a programming language is the advanced business application programming (ABAP) language. ABAP includes a workbench that offers tools for use in developing business applications. In more detail, the ABAP workbench supports the development and modification of client/server applications written in ABAP, and includes tools that can be used to write ABAP code, design screens, and create UIs.

Beyond the workbench, the designer or developer may utilize an integrated development environment (IDE), which is computer software that enables computer programmers to develop other software, such as ABAP and others. The IDE typically includes a source code editor, a compiler, an interpreter, build-automation tools, and a debugger. IDEs that are used for developing object-oriented software may also include a class browser, an object inspector, and a class hierarchy diagram. Within such an IDE, the application can often be developed using modeling systems. In general, these models can specify the types of development objects or components that can be used to build applications, as well as the relationships that can be used to connect those components.

Regardless of the particular development process or tool used, part of the development process is the creation or use of guidelines. Many existing guidelines can share common parts, but often differ in some parts. Further, in many cases the better guidelines are never fixed once, but are instead often changing. In other words, such prior guidelines were created as monolithic documents that were settled on a “local” basis. Accordingly, the benefits were acknowledged on a lower scale but were not fully realized by unifying the particular development entity (such as a company, a department, and other inter-project groups). For example, one potential reason is that adopting a unifying guideline could immediately make other guidelines more obsolete.

### SUMMARY

This disclosure relates to creating, facilitating, or otherwise managing unified development guidelines. For example, software for managing development guidelines can comprise computer readable instructions embodied on media. This software can be operable when executed to, in response to a trigger, identify a first guideline rule and a second guideline rule based, at least in part, on the trigger, where the guideline rules are at least partially stored in a central rules repository for a development group and each rule is associated with a validity period. This example software then generates a development guideline using the identified first guideline rule and the second guideline rule.

The foregoing example software—as well as other disclosed processes—may also be computer implementable methods. Moreover, some or all of these aspects may be further included in respective systems or other devices for executing, implementing, or otherwise supporting unified development guidelines. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example system for creating, facilitating, or otherwise managing unified development guidelines in accordance with one embodiment of the present disclosure; and

FIG. 2 illustrates an example method for managing unified development guidelines in accordance with one embodiment of the present disclosure.

### DETAILED DESCRIPTION

This disclosure generally describes an example environment 100 for creating, managing, and implementing development guidelines 145 for software development, perhaps using a graphical user interface (GUI) modeling or development environment 130. Instead of creating a monolithic guideline, the present disclosure by and large considers guidelines as a set of self contained rules that can be reviewed, approved, and improved separately. Generally, the disclosure describes the establishment and maintenance of a development guideline that can help ensure higher developer acceptance, clarity as to what each rule means and how stringent it will be applied, and account for changes (e.g., in the ABAP language or for new development approaches). For example, the disclosure may use a wiki-like mechanism during guideline rule creation, while still delivering fixed sets of guidelines, often because the developer may not be able to stabilize his code while adapting for quickly changing rules. Establishing the development or implementation guidelines may include generation of requirements for automatic testing. In some cases, these guidelines are especially well suited situations with a high potential for controversial discussions. In various implementations or environments, these unified development guidelines can help reduce time to handover programs (perhaps because of the reduced or eliminated need to adapt to changing implementation styles), reduce overhead during program maintenance (perhaps because of increased ease in spotting errors if implementation styles do not vary overly much), reduce overhead at start of projects (perhaps because of reduced discussion to agree for common guidelines), as well as benefit the implementing organization in numerous other potential ways.

Environment 100 is typically a distributed client/server system that spans one or more networks, such as 112. In some cases, environment 100 represents an organization's IT or development department and executes various portions of development environment 130. Put another way, environment 100 may be in a dedicated enterprise environment—across a local area network or subnet—or any other suitable environment without departing from the scope of this disclosure. In other cases, rather than being delivered as packaged software, portions of environment 100 may represent a hosted solution, often for an enterprise or other small business, that may scale cost-effectively and help drive faster adoption. In this case, portions of the hosted solution may be developed by a first entity, while other components are developed by a second entity. Moreover, the processes or activities of the hosted solution—such as development guidelines 145—may be distributed amongst these entities and their respective components.

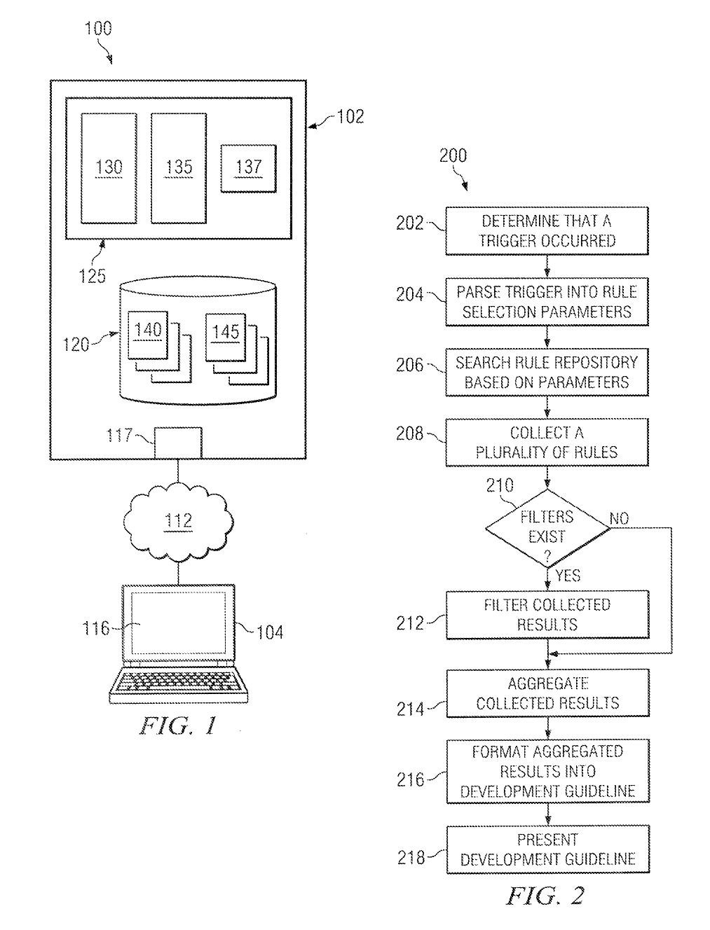

Turning to the illustrated embodiment, environment 100 includes or is communicably coupled with server 102 and one or more clients 104, at least some of which communicate across network 112. Server 102 comprises an electronic computing device operable to receive, transmit, process and store data associated with environment 100. For example, server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). But, more generally, FIG. 1 provides merely one example of computers that may be used with the disclosure. Each computer is generally intended to encompass any suitable processing device. For example, although FIG. 1 illustrates one server 102 that may be used with the disclosure, environment 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server (capable of managing a wiki-like website for the guidelines) and/or a mail server.

Server 102 often includes local memory 120. Memory 120 may include any memory or database module and may take the form of volatile or non-volatile memory including, without limitation, magnetic media, optical media, random access memory (RAM), read-only memory (ROM), removable media, or any other suitable local or remote memory component. Illustrated memory 120 includes one or more guideline rules 140 and—at some point—one or more compiled, instantiated, or otherwise generated development guidelines 145. But memory 120 may also include any other appropriate data such as HTML files or templates, data classes or object interfaces, unillustrated software applications or sub-systems, and others. For example, memory 120 may include pointers or other references to one or more guideline rules 140 that were published to a location remote from server 102. In this way, a local developer or non-technical business analyst may use a remote guideline rule 140 to efficiently supplement the particular development guideline 145 that he is managing.

Regardless of location, guideline rules 140 generally provide a distinct logical rule that applies to one or more software development projects. In other words, each guideline rule is at least operable to be reused across departments, applications, projects, or other applicable physical or logical distinctions. The guideline rules 140 often follow a common format that allows disparate developers to easily understand the particular rule, as well as quickly create new rules 140 or change existing rules 140. For example, each guideline rule 140 may include one or more of the following items:

A rule ID. This ID will be used to track the rule and to enable maintenance of the guideline. The proposed format of the ID is ggggggg.nnnnnn.mm, where ggggg is the abbreviated name of the guideline, nn is a number to differentiate rules of a given guideline, and mm the version number

Example: ABAP000001.01 for the first version of the first rule of the ABAP guidelines.

The version is typically increased as a rule evolves.

Keywords. Some keywords that allow a user to easily search a rule. Predefined keywords or other metadata are feasible.

A priority field describing how binding the rule is. Example possible values are

1 Obligatory—the rule is mandatory and is to be obeyed. If possible, it will be implemented into some check tool as a priority 1 error, e.g., syntax check, extended program check, code inspector, and the like. Exceptions to the rule are not possible but for very special reasons. Justification of the violation is required. At least one other developer and/or architect must acknowledge that the violation is justified. The violation should be commented in the code accordingly.

2 Strongly Recommended—the rule is strongly recommended and should be obeyed. If possible, it will be implemented into some check tool as a priority 2 error. Exceptions to the rule are possible, but need explicit justification. The violation must be commented in the code accordingly.

3 Recommended—the rule is recommended and should be obeyed. If possible, it will be implemented in some check tool as a priority 3 error. Exceptions to the rule are possible. Justifications are not needed, but developers need to explicitly acknowledge that they knowingly ignore the rule.

4 Hint—the rule is a hint at how things could be done better for some cases. Depending on the circumstances each developer may decide to ignore this rule without further comment. Hints are intended for rules that are very specific, very new, or where it is clear that they cannot be applied.

An approval status field describing the current approval status of a rule. The example possible values are:

0 Obsolete—the rule is obsolete and can be ignored.

1 Proven—the rule has been established for some time (typically >1 year) and benefits of the rule are generally agreed.

2 Released—the rule is released. For example, it may have passed reviews (or otherwise been reviewed), but it may be unclear if it will deliver anticipated results benefits.

3 For Review—the rule was already proposed and discussed for some time but not yet formally reviewed and accepted.

4 New—the rule is new.

The meaning of status and priority combinations is such that the priority is always the intended binding no matter what the approval status is. Example: “Obligatory New” means a new rule that is intended to become obligatory at some point in time. “Hint Obsolete” means a hint that is no longer relevant.

A responsible field that describes who is responsible for the rule.

A last change field that describes who changed the rule for the last time.

A “valid from” and “valid to” field describing for which period of time the rule will be applicable.

A rule body. This is the actual rule. Rules can use the key words “Mandatory,” “must,” “shall,” and “forbidden” within obligatory rules. The key word “should always” and “strongly recommended” should be used within strongly recommended rules. The key words “should” and “recommended” should be used within recommended rules. And “hint” or “might” should be used for hints. It is recommended that each rule be as self-contained as possible, which could allow it to be understandable without (external) references.

A rationale field that explains why the rule is reasonable and what the expected benefits are.

A known problems field that describes known problems.

An exceptions field that describes valid exceptions to the rule.

A poor example that describes how not to do it.

A good example that describes how to implement it.

Generally, problems that arise with the “released” rules can be fixed any time and the validity of a new version is set to “review date+reasonable latency time” with some reasonable time to allow for transition. “Proven” rules should not normally require fixes by definition. But if fixes are to be implemented, then the validity is usually such that the new rule applies to future releases. Put another way, changes to “Proven” during the last six (6) weeks of the implementation cycle are typically not admissible. If a rule is to be technically enforced (e.g. checkman, extended program check, code inspector), then it must (in some implementations) reach the status “proven” beforehand.

### EXAMPLE 1

Rule: DevProcProp000001v1

Keywords: Literature

Priority: Hint

Status: New

Responsible: Klein, Udo (Emp. No. 123)

Last changed: 2009 11 24 by Klein, Udo (Emp. No. 123)

Valid from: 2009 11 24

Valid to: unlimited

Body:

Each developer should order the book “ISBN 123456789” and read it.

Rationale:

This is one of the best books about software construction.

Known problems:

Not all of the rules in this book are applicable at to certain departments.

Bad example:

Order the book and put it on the shelf to impress your colleagues.

Good example:

Read the book and apply and try to learn as much as possible.

### EXAMPLE 2

RuleID: DevProcProp000002v1

Keywords: ABAP, style

Priority: Strongly recommended

Status: For Review

Responsible: Klein, Udo (Emp. No. 123)

Last changed: 2009 11 24 by Klein, Udo (Emp. No. 123)

Valid from: 2009 01 01

Valid to: unlimited

Body:

Do not code more than one ABAP statement per line.

Rationale:

1) The debugger can only visualize in which line ABAP is processing. It is difficult to differentiate where in a line processing happens.

2) Pushing too much into a line makes code harder to read.

Known problems:

Functional method calls within IF statements can be counted as a second statement in a single line. Breaking it up in different lines makes code harder to read.

Exceptions:

1) In combinations with IF, CASE, WHEN, or WHILE statements, functional method calls are admissible.

2) WRITE statements

Bad example:

CLEAR: a, b.

WRITE ‘x contains’.

WRITE x.

Good example:

CLEAR a.

CLEAR b.

WRITE: ‘x contains’, x.

Of course, the foregoing examples are for illustration purposes and may not represent each rule 140. In other words, each rule 140 may have none, some, or all, as well as other fields and data within the scope of the present disclosure. Regardless of the individual formats of each rule 140, these rules are generally operable to be selected, collected, and compiled into a logically cohesive development guideline 145.

Some or all of the guideline rules 140 and the development guidelines 145 may be stored or referenced in a local or remote development repository. For example, this repository may include parameters, pointers, variables, algorithms, instructions, rules, files, links, or other data for easily providing information associated with or to facilitate modeling of the particular object. More specifically, each repository may be formatted, stored, or defined as various data structures in HTML, PHP (PHP: Hypertext Preprocessor), eXtensible Markup Language (XML) documents, text files, Virtual Storage Access Method (VSAM) files, flat files, Btrieve files, comma-separated-value (CSV) files, internal variables, one or more libraries, or any other format capable of storing or presenting the objects and their respective methods in a hierarchical form, such as a tree with multiple nodes. In short, each repository may comprise one table or file or a plurality of tables or files stored on one computer or across a plurality of computers in any appropriate format as described above. Indeed, some or all of the particular repository may be local or remote without departing from the scope of this disclosure and store any type of appropriate data.

By following a plurality of these guideline rules 140, the developer (or other analyst or his team) can easily request or follow a development guideline 145 that is consistent across the particular organization. Moreover, these guidelines 145 are normally flexible and allow the particular project to be customized for the respective environment or situation, while still maintaining the consistent look-and-feel. In some cases, the developer may use a personalized, secure interface that helps unify enterprise applications, information, and processes into a coherent, role-based portal experience. Further, the modeling environment may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements, all while following these consistent and easily readable guidelines 145. Classification tools may automate the organization of information, while subject-matter experts and content managers can publish information to distinct user audiences. In other cases, the developer may code using ABAP or other programming languages to create portions of all of an enterprise application 135. The deployed model or application 135 may then be modified or enhanced as appropriate using the development environment 130, which is typically executed on one or more processors.

For example, illustrated server 102 includes one or more processors 125. The processor 125 may be a central processing unit (CPU), a blade, an application specific integrated circuit (ASIC), or a field-programmable gate array (FPGA). The processor 125 may execute instructions and manipulate data to perform the operations of server 102. Although FIG. 1 illustrates one processor 125 in server 102, only one or more than one processor may be used according to particular needs or desires of environment 100. In the illustrated embodiment, processor 125 executes model-driven development tool (or environment) 130, business application 135, and rule manager 137.

These unified development guidelines may be (at least partially) implemented within or control the use of the development environment 130. Generally, the development environment 130 may be any development tool, toolkit, application programming interface (API), application, or other framework that allows a developer to develop, configure, and utilize data and software objects that can be more easily modeled during modeling (or during design time) of a particular business application. For example, the model-driven framework or environment may allow the developer to use simple drag-and-drop techniques to develop pattern-based or freestyle user interfaces and define the flow of data between them, including deeper hierarchical data. Such drag-and-drop techniques may include selecting, inputting, identifying, or some other indication that the developer is interested in a particular object or element. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In other cases, the development environment 130 may be a workbench or other studio product that allows the developer to graphically or manually code portions of an enterprise software solution within environment 100.

At a high level, business application 135 is any application, program, module, process, or other software that may execute, change, delete, generate, or otherwise manage business information according to the present disclosure. In certain cases, environment 100 may implement a composite application 135. For example, portions of the composite application may be implemented as Enterprise Java Beans (EJBs) or design-time components, and may have the ability to generate run-time implementations in different platforms, such as J2EE (Java 2 Platform, Enterprise Edition), ABAP (Advanced Business Application Programming) objects, or Microsoft's .NET. As noted above, ABAP is a programming language for use in developing business applications. Memory 120 may store an ABAP dictionary in a library. The ABAP dictionary contains data describing the logical structure of application development objects and their representations. ABAP runtime environment components, such as application programs or a database interface, obtain information about these objects from the ABAP dictionary. Computer programs, such as business application 135, make use of information from the ABAP dictionary during application development. In ABAP, there are different types of data, such as integer, character field, structure and internal table. The ABAP workbench contains a toolset that enables developers to customize and extend existing applications or create new applications. ABAP is keyword-oriented, meaning that a keyword is the first word in an ABAP statement, and determines the meaning of the entire statement. For example, there are four different types of ABAP keywords: declarative keywords, event keywords, control keywords, and operational keywords. Each of these precedes a corresponding statement.

Further, while illustrated as internal to server 102, one or more processes associated with business application 135 may be stored, referenced, or executed remotely. For example, a portion of application 135 may be a web service that is remotely called, while another portion of application 135 may be an interface object bundled for processing at remote client 104. Moreover, application 135 may be a child or sub-module of another software module or enterprise application (not illustrated) without departing from the scope of this disclosure. Additionally, in some instances, application 135 may be a hosted solution that allows multiple parties in different portions of the process to perform the respective processing. For example, client 104 may access business application 135 on server 160, or even as a hosted application located over network 120, without departing from the scope of this disclosure. In another example, portions of business application 135 may be used by an authorized user working directly at server 160, as well as remotely at client 104. In yet another example, business application 135 may be hosted by a third party entity for use by a remote client 104 authorized by the taxpaying entity. Regardless of the particular implementation, “software” may include software, firmware, wired or programmed hardware, or any combination thereof as appropriate. Indeed, each software component may be fully or partially written or described in any appropriate computer language including C, C++, Java, Visual Basic, assembler, Perl, any suitable version of 4GL, as well as others.

More specifically, business application 135 may be a composite application, or an application built on other applications, that includes an object access layer (OAL) and a service layer. In this example, business application 135 may execute or provide a number of application services such as customer relationship management (CRM) systems, human resources management (HRM) systems, financial management (FM) systems, project management (PM) systems, knowledge management (KM) systems, and electronic file and mail systems. Such an OAL is operable to exchange data with a plurality of enterprise-based systems and to present the data to a composite application through a uniform interface. The example service layer is operable to provide services to the composite application. These layers may help composite application 135 to orchestrate a business process in synchronization with other existing processes (e.g., native processes of enterprise-based systems) and leverage existing investments in the IT platform. Further, composite application 135 may run on a heterogeneous IT platform. In doing so, composite application 135 may be cross-functional in that it may drive business processes across different applications, technologies, and organizations. Accordingly, composite application 135 may drive end-to-end business processes across heterogeneous systems or sub-systems. Application 135 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 135, it may instead be a standalone or (relatively) simple software program. Regardless, application 135 may also perform processing automatically, which may indicate that the appropriate processing is substantially performed by at least one component of environment 100. It should be understood that this disclosure further contemplates any suitable administrator or other user interaction with application 135 or other components of environment 100 without departing from its original scope.

Rule manager 137 comprises any software operable to at least partially manage guideline rules 140 and/or development guidelines 145. While it may be coupled with development environment 130, it is often a web server application and/or a client-side applet that allows the user to input a new guideline rule 140 via an interface or generates a development guideline 145 from a plurality of rules 140 (perhaps automatically based on some trigger), which is then presented via the interface. More specifically, rule manager 137 may present an entry or input interface screen, a modification screen, or a selection screen to help manage rules 140. Moreover, rule manager 137 may (alternatively or in combination) include logic operable to receive, select, determine, or otherwise identify that an internal or external trigger occurred and collect a plurality of rules 140 in response to this trigger, as well as to generate—or retrieve an existing—development guideline 145. These triggers may include a request for proposal (RFP), initiation or completion of a development stage (such as requirement gathering, risk analysis, design, approval, modeling, coding, unit testing, system testing, installing, modifying, upgrading, patching, and so forth), a project kick-off, a manual request, documentation, staffing change, intellectual property review, intellectual property protection, and others.

Regardless of the particular implementation, “software” may include software, firmware, wired or programmed hardware, or any combination thereof as appropriate. Indeed, each software component may be fully or partially written or described in any appropriate computer language including C, C++, Java, Visual Basic, assembler, Perl, any suitable version of 4GL, as well as others. It will be understood that while the software illustrated in FIG. 1 is shown as a single module that implements the various features and functionality through various objects, methods, or other processes, the software may instead include a number of sub-modules, third party services, components, libraries, and such as appropriate. Conversely, the features and functionality of various components can be combined into single components as appropriate.

Server 102 may also include interface 117 for communicating with other computer systems, such as clients 104, over network 112 in a client-server or other distributed environment. In certain embodiments, server 102 receives data from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals. Interface 117 may allow communications across network 112 via a virtual private network (VPN), SSH (Secure Shell) tunnel, or other secure network connection.

Network 112 facilitates wireless or wireline communication between computer server 102 and any other local or remote computer, such as clients 104. Network 112 may be all or a portion of an enterprise or secured network. In another example, network 112 may be a VPN merely between server 102 and client 104 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between server 102 and at least one client 104. In other words, network 112 encompasses any internal or external network, networks, sub-network, or combination thereof operable to facilitate communications between various computing components in environment 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and certain local or remote clients 104.

Client 104 is any computing device operable to connect or communicate with server 102 or network 112 using any communication link. At a high level, each client 104 includes or executes at least GUI 116 and comprises an electronic computing device operable to receive, transmit, process and store any appropriate data associated with environment 100. It will be understood that there may be any number of clients 104 communicably coupled to server 102. Further, “client 104,” “developer,” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. As used in this disclosure, client 104 is intended to encompass a personal computer, touch screen terminal, workstation, network computer, kiosk, wireless data port, smart phone, personal data assistant (PDA), one or more processors within these or other devices, or any other suitable processing device. For example, client 104 may be a PDA operable to wirelessly connect with external or unsecured network. In another example, client 104 may comprise a laptop that includes an input device, such as a keypad, touch screen, mouse, or other device that can accept information, and an output device that conveys information associated with the operation of server 102 or clients 104, including digital data, visual information, or GUI 116. Both the input device and output device may include fixed or removable storage media such as a magnetic computer disk, CD-ROM, or other suitable media to both receive input from and provide output to users of clients 104 through the display, namely, the client portion of GUI or application interface 136.

GUI 116 comprises a graphical user interface operable to allow the user of client 104 to interface with at least a portion of environment 100 for any suitable purpose, such as viewing application, modeling, or hierarchical data. Generally, GUI 116 provides the particular user with an efficient and user-friendly presentation of data provided by or communicated within environment 100. More specifically, GUI 116 can include a modeling editor. The modeling editor can be connected with the development environment 130 (or other development environment) such that the modeling editor and/or the development environment 130 can automatically generate an application model (e.g., a model of an application that is being developed) from a graphical model and/or vice versa. In other cases, GUI 116 may comprise a web browser that includes a plurality of customizable frames or views having interactive fields, pull-down lists, and buttons operated by the user. For example, GUI 116 is operable to display certain presentation elements, such as wiki pages and links, in a user-friendly form based on what the user, or developer, is trying to accomplish. GUI 116 may also present a plurality of portals or dashboards. For example, GUI 116 may display a portal that allows developers or information managers to view, create, and manage guideline rules 140. GUI 116 is often configurable, supporting a combination of tables and graphs (bar, line, pie, status dials, etc.) and is able to build real-time dashboards and wiki-like pages. It should be understood that the term “graphical user interface” may be used in the singular or in the plural to describe one or more graphical user interfaces and each of the displays of a particular graphical user interface. Indeed, reference to GUI 116 may indicate a reference to the front-end or a component of any application or software, as well as the particular interface accessible via client 104, as appropriate, without departing from the scope of this disclosure. Therefore, GUI 116 contemplates any graphical user interface, such as a generic web browser or touchscreen, that processes information in environment 100 and efficiently presents the results to the user. Server 102 can accept data from client 104 via the web browser (e.g., Microsoft Internet Explorer or Mozilla Firefox) and return the appropriate HTML or XML responses to the browser using network 112.

Regardless of the particular hardware or software architecture used, environment 100 is generally capable of managing at least a portion of guideline rules 140, presenting certain rules 140 through interface 116 for viewing and potential use by others, and facilitating development processes and techniques. The following descriptions of the flowcharts focus on the operation of rule manager 137 in performing the respective method. But system 100 contemplates using any appropriate combination and arrangement of logical elements implementing some or all of the described functionality. For example, some of the processing or other techniques may be implemented by development environment 130 or other invoked or referenced libraries or sub-modules not illustrated.

FIG. 2 is a flowchart illustrating an example method 200 for managing development guidelines 145, which dynamically include a plurality of guideline rules 140. Specifically, method 200 involves a common description pattern applicable for rules of a guideline and a life cycle (or maintenance process) for guideline rules. The description pattern is introduced in order to force guideline authors to a clear and easily understandable style. Thus, the pattern can help make the guidelines easily understandable and can help increase developer acceptance. Further, it may help to support the proposed process. In some implementations, this process is designed in a way similar to the process for dealing with, for example, ABAP code. This can ensure that the process is easily understood by the developers. Further, the assumption is that this process can be more easily implemented if existing tools (e.g., the existing support system for code) can be reused. An initial set of guidelines can be established by a dedicated group. In some organizations, there may be an owner for most or all rules 140, such that the rules can effectively evolve. In some cases, method 200 involves creating development guideline rules with respect to a life cycle similar to that with code. In other words, there can be releases of the guideline rules or development guidelines themselves. In such instances, method 200 indicates that, at the beginning of each code implementation cycle (e.g., kick-off for a new release), the current set of “released” and “proven” rules 140 is collected into a “guideline document” 145. This set of guidelines is generally what the developers follow during the respective development.

More specifically, illustrated method 200 begins at step 202, where some particular trigger is identified or the occurrence of which is determined. For example, rule manager 137 may receive a manual trigger from a developer or project manager, such as via an internal or coupled interface 116, that a particular development process has begun. In another example, rule manager 137 may receive an automatic message from development environment 130 or a project management system that a new requirement collection is taking place. At step 204, rule manager 137 parses this trigger into rule selection parameters. These parameters may be a manual selection of specific rules 140, an identification of the development phase, an identification of the application field or scope, a client or client type identifier, a region or language identifier, a security parameter, and so on. This parsing may include identification of particular parameters, dynamically determining particular parameters, receiving particular parameters in addition to the trigger, identifying parameters based on a user profile, or any combination thereof.

Next, rule manager 137 searches one or more rules repositories, such as that stored in memory 120, at step 206. As described above, these rules repositories may be local or remote, which can include third party sites as well. For example, a central repository for “global” rules 140 may be provided by a third party website, while enterprise-specific rules 140 may be stored in a local intranet server 102. Based on this search, rule manager 137 collects a plurality of rules 140 that are—at least initially—suitable for use in a development guideline 145 at step 408. The rule manager 137 may filter these rule results using any suitable criteria at step 412, if such filters exist and are appropriate (as shown at decisional step 410).

The collected results are then aggregated and formatted to form a cohesive, unified development guideline 145 at step 214 and 216, respectively. This aggregation may include prioritization, sorting, removal of duplicates or substantially similar rules 140, and so forth. The formatting may include conversion (such as between languages or rule formats), putting into graphical or web-based format, and so on. Method 200 then presents the development guideline 145 at step 218, often via interface 116. For example, the rule manager 137 may create a PDF report and email it to the team members. In another example, the rule manager 137 may create a web page or HTML component for presentation on each member's portal. In yet another example, the rule manager 137 may create a new wiki-like entry in a development guideline microsite.

The preceding figure and accompanying description illustrate processes and implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. For example, the collecting, filtering, aggregation, and formatting may all occur within the same logical process at substantially the same time. In addition, many of the steps in these processes may take place simultaneously and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. Software for managing development guidelines comprising computer readable instructions embodied on media and operable when executed to:
in response to a trigger, identify a first guideline rule and a second guideline rule based, at least in part, on the trigger, the guideline rules at least partially stored in a central rules repository for a development group and each rule associated with a validity period; and
generate a development guideline using the identified first guideline rule and the second guideline rule.

2. The software of claim 1, the first guideline rule comprising a released rule and the software further operable to receive a change to the released rule via an interface.

3. The software of claim 2 further operable to:
provide the changed first guideline rule for review; and
change the validity period of the first guideline rule to begin after a review date.

4. The software of claim 2, the second guideline rule comprising a proven rule and the software further operable to reject proposed changes to the second guideline rule.

5. The software of claim 4, the proven rule associated with a plurality of triggers.

6. The software of claim 5, the proven rule further associated with a plurality of applications.

7. The software of claim 4, the software rejecting the proposed changes only upon reaching a time threshold in a development process associated with the trigger.

8. The software of claim 1, the development guideline associated with a plurality of triggers and operable to be reused for a second of the triggers, the second trigger associated with a different portion of the development group than the first trigger.

9. The software of claim 1 further operable to present the generated development guideline to a plurality of clients associated with the trigger.

10. The software of claim 1, the trigger comprising a code implementation cycle.

11. The software of claim 1, the first guideline rule comprising a wiki that includes:
a unique rule identifier;
a keyword;
a priority field;
an approval status;
a responsible field;
a rule body; and
a rationale field.

12. The software of claim 11, the rule identifier comprising a first structure associated with a development process, a second structure associated with a rule number, and a version number.

13. A computer implemented method comprising:
in response to a trigger, identifying a first guideline rule and a second guideline rule based, at least in part, on the trigger, the guideline rules at least partially stored in a central rules repository for a development group and each rule associated with a validity period; and
receiving a generated development guideline, associated with the identified first guideline rule and the second guideline rule, via an interface.

14. The method of claim 13, the first guideline rule comprising a released rule and the method further comprising applying a change to the released rule via the interface.

15. The method of claim 14 further comprising providing the changed first guideline rule for review, the validity period of the first guideline rule automatically changing to begin after a review date.

16. The method of claim 14, the second guideline rule comprising a proven rule and the software further operable to reject proposed changes to the second guideline rule.

17. The method of claim 16, the proven rule associated with a plurality of triggers and further associated with a plurality of applications.

18. The method of claim 16, rejecting the proposed changes only upon reaching a time threshold in a development process associated with the trigger.

19. The method of claim 13, the trigger comprising a first trigger, the development guideline associated with a plurality of triggers and operable to be reused for a second of the triggers, the second trigger associated with a different portion of the development group than the first trigger.

20. The method of claim 13, the trigger comprising a code implementation cycle.

21. The method of claim 13, the first guideline rule comprising a wiki that includes:
a unique rule identifier, the rule identifier comprising a first structure associated with a development process, a second structure associated with a rule number, and a version number;
a keyword;
a priority field;
an approval status;
a responsible field;
a rule body; and
a rationale field.

22. The method of claim 21 further comprising adding a new rule to the central rules repository using the interface, the new rule comprising the wiki format and the new rule's approval status comprising a new status.

23. The method of claim 22 further comprising updating the approval status of the new rule using the interface from new to under review.

24. A system for managing inter-process development guidelines comprising:
memory storing:
a first guideline rule, a second guideline rule, and a third guideline rule, each rule associated with a validity period; and
a development guideline based on the first and second guideline rules, the development guideline associated with a plurality of subsets of a development group; and
one or more processors providing an interface operable to manage the guideline rules and to present the development guideline.
